(19) United States
(12) Patent Application Publication
(10) Pub. No.: US 2018/0196013 A1
(43) Pub. Date: Jul. 12, 2018

(54) TRACKING DEFECTS WITH PERMANENTLY INSTALLED SENSORS

(71) Applicant: SENSOR NETWORKS, INC., Boalsburg, PA (US)

(72) Inventors: James Barshinger, State College, PA (US); Bruce A. Pellegrino, Far Hills, NJ (US)

(21) Appl. No.: 15/865,829

(22) Filed: Jan. 9, 2018

Related U.S. Application Data
(60) Provisional application No. 62/444,138, filed on Jan. 9, 2017.

(51) Int. Cl. G01N 29/265; G01S 5/18; G01N 29/44; G01B 17/02; G01N 29/24; G01N 29/22; G01N 29/34

(52) U.S. Cl. CPC G01N 29/265; G01S 5/18; G01N 29/4445; G01N 29/348; G01N 29/24; G01N 29/226; G01B 17/02

(57) ABSTRACT

A method of monitoring defects in a structure, the method comprising the steps of: (a) detecting the potential for a defect in the structure using a first detection method; (b) identifying the location on the structure of the defect using a second detection method; (c) determining if the defect exceeds an allowable limit, and, if so, transmitting information that the structure needs to be repaired; (d) if the defect does not exceed the allowable limit, then monitoring the structure by applying permanently installed ultrasonic sensor to the location; and (e) after step (d), repeatedly performing step (c) until the defect exceeds the allowable limit.

### REFERENCE TO RELATED APPLICATION

This application is based on U.S. Provisional Application No. 62/444,138, filed Jan. 9, 2017, and is hereby incorporated by reference.

### FIELD OF INVENTION

This patent application relates, generally, to a system and method for monitoring and tracking the growth of defects in industrial assets, particularly pipes, tanks and other types of pressure/product holding vessels, and, more specifically, to a system and method for ultrasonic nondestructive testing of these assets to size and monitor defects so that predictive maintenance practices can take place.

### BACKGROUND

Fitness for service of plant assets is critical for the continued health, management and maintenance of industrial facilities. When plants are in operation, nondestructive testing such as ultrasonic thickness gauging, ultrasonic flaw detection and radiography is routinely done to detect and size defects. Perhaps in an ideal world, all flaws would be immediately mitigated by repair or replacement of the asset. However, in practice, assets are designed with an allowance for flaws and degradation, and continued safe operation is accomplished by nondestructive testing and monitoring. For example, ultrasound can be used to monitor wall thickness near a known defect. Traditionally, this is done on a periodic basis with a handheld sensor.

While manual thickness gauging is a widely used and accepted, it necessitates that the operator contact a probe to the part surface. This can be inconvenience and expensive due to the cost of access—e.g., scaffolding, insulation removal, hazardous area access, etc. Furthermore, the accuracy of this technique varies given the variable in positioning the probe, operator variability, the use of different equipment, etc.

What is needed is a way of safely continuing the useful life of an asset having known defects without the inconvenience and expense of periodically checking the condition of the defects.
The present invention fulfills this need, among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Applicants recognize that using permanently installed sensors to monitor the severity of known defects may be used to extend safely the useful life of an asset having known defects. Specifically, by locating the sensors proximate to known defects, the defects can be monitored conveniently, and calculations run frequently whether the size of the defect is within allowable limits and thus ensure the safe operation of the asset. Moreover, Applicants recognize that, in one embodiment, different techniques can be used to test the asset to determine the existence and location of any defects. That is, in one embodiment, a quick method may be used to determine whether the asset has defect, and then a different, more time consuming, method may be used to determine where the defect is located. Accordingly, time is not wasted with a precise defect-locating method when a defect does not exist. Once the defect, if any, is located, then permanently installed sensors may be installed to continue to monitor the defect and ensure it remains within safe operating limits. It should be understood that these different testing method may be performed by the user or by others under the control of a single user. In other words, although the user may not perform the inspection techniques, it can cause the inspection to be performed and use the inspection data to install the sensors and monitor the defects.

Accordingly, in one embodiment, a method is disclosed for monitoring defects in a structure to extend the useful operating life of the asset, the method comprising the steps of: (a) determining a location of a defect in the asset; (b) causing at least one permanently installed ultrasonic sensor to be installed at the location to monitor the defect; and (c) periodically determining whether the defect is within an allowable limit for safe operation.

In one embodiment, the invention relates to a system for monitoring defects in a structure, the system comprising: a sensor interface configured to receive signals from one or more sensors disposed on a surface of the structure at the location of a defect, the signals relating to the extent of the defect; a user interface for communicating to a user when the defect exceeds an allowable limit for the defect; a processor; and memory configured with instruction for causing the processor to execute at least the followings steps: (a) receiving the signals from the sensor interface relating to the extent of the defect; (b) determining if the defect exceeds the allowable limit, and, if so, transmitting information via the user interface that the structure needs to be repaired; and (c) periodically reiterating steps (a)-(b) until the defect exceeds the allowable limit.

In another embodiment, the invention relates to a method of monitoring defects in a structure, the method comprising the steps of: (a) detecting the potential for a defect in the structure using a first detection method; (b) identifying the location on the structure of the defect using a second detection method; (c) determining if the defect exceeds an allowable limit, and, if so, transmitting information that the structure needs to be repaired; (d) if the defect does not exceed the allowable limit, then monitoring the structure by applying permanently installed ultrasonic sensor to the location; and (e) after step (d), repeatedly performing step (c) until the defect exceeds the allowable limit.

### BRIEF DESCRIPTION OF FIGURES

FIG. 1 is a schematic of one embodiment of the system of the present invention.

### DESCRIPTION

Applicants recognize that there are advantages in monitoring industrial assets by performing a sequence of inspection steps, culminating in the use of permanently installed sensors to monitor defects, the results of such monitoring being continual evaluation of the asset's fitness for service. The following is one embodiment of the process of the claimed invention.

In an initial step, detection of a potential defect is performed using a first method which, in one embodiment, is a general screening method. The first method tends to be one which detects the potential for a defect or general degradation of an asset. The actual location of the defect may not be known. Examples of first methods include, for example, using an ILI tool to detect flaws in a natural gas transmission pipe, or radiography to detect wall thickness loss. Generally, although not necessarily, the result of this step is the identification of an area of interest that requires further measurement. In one embodiment, the user performs the first method. In another embodiment, the first method is performed by others and the results or information from the first method are provided to the user to enable the user to conduct the subsequent steps below, or otherwise cause the subsequent steps to be performed.

Next, a second method is used to locate the defects in the asset. In one embodiment, the second method is different from the first method. For example, in one embodiment, a nondestructive evaluation (NDE) scan is performed. Generally, although not necessarily, this involves using ultrasound. In this step, preferably, automated ultrasonics are used to map the asset to find very particular areas (e.g., the deepest pits) to be monitored. Generally, although not necessarily, the result of this step is the identification of the size and location of the most severe flaws. In one embodiment, the user performs the second method. In another embodiment, the second method is performed by others, and the results or information from the second method are provided to the user to enable the user to conduct the subsequent steps below, or otherwise cause the subsequent steps to be performed.

Next, in one embodiment, a fitness determination is made based on the results of the second method. For example, in one embodiment, a determination is made whether the defects are within allowable limits, and whether the asset can remain in service. For example, the defect may be a pit or crack in the wall of a pipe and the allowable limit may be the remaining thickness of the pipe at the location of the pit/crack. Such allowable limits are well known in the industry. In one embodiment, the user performs this calculation, and, in another embodiment, the calculation is performed by others, and the results or information from the calculation are provided to the user to enable the user to make a decision to keep the asset in service or otherwise cause subsequent steps to be performed.

If the asset is kept in service, the next step involves monitoring the defect to ensure it does not exceed allowable limits. In one embodiment, continuous, semicontinuous, or periodic monitoring of the asset is performed by applying permanently installed ultrasonic sensors to the critical defect areas. For example, transducers may be placed on individual critical pits to monitor them on a daily, weekly or monthly basis. In one embodiment, the user installs the permanently installed ultrasonic sensors, and, in another embodiment, the permanently installed ultrasonic sensors are installed by others, and the information derived from the sensors is provided to the user. In one embodiment, the permanently-installed ultrasonic sensors and DSI are disclosed in Publication No. 2016/0274065, application Ser. No. 14/839,694, and application Ser. No. 15/814,040, all of which are hereby incorporated by reference in their entirety, including those references incorporated by reference therein.

At this point, the asset's fitness for service may be calculated as need be as the permanent monitoring continues.

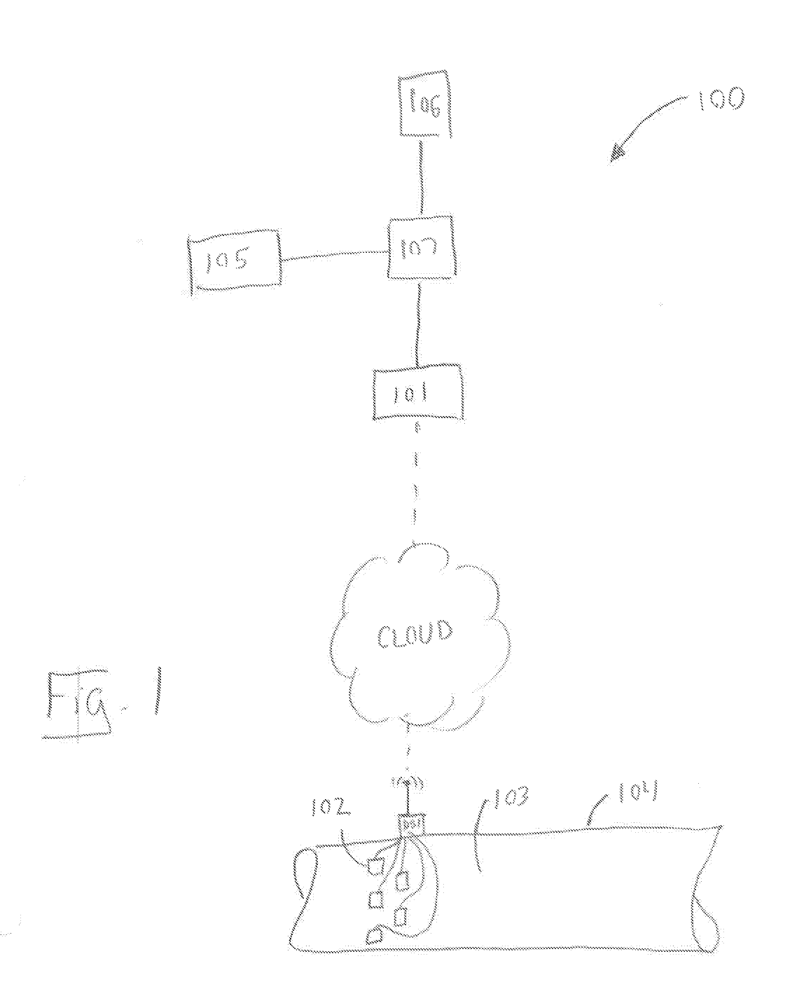

Referring to FIG. 1, a schematic of one embodiment of the system 100 of the present invention for monitoring defects is disclosed. The system comprises: a sensor interface 101 configured to receive signals from one or more sensors 102 disposed on a surface 103 of a structure 104 at the location of a defect (not shown). The signals relate to the extent of the defect. The system 100 also comprises a user interface 105 for communicating to a user when the defect exceeds an allowable limit for the defect. The system comprises a memory 106 configured with instruction for causing a processor 107 to execute at least the followings steps: (a) receiving the signals from the sensor interface 101 relating to the extent of the defect; (b) determining if the defect exceeds the allowable limit, and, if so, transmitting information via the user interface 105 that the structure 104 needs to be repaired; and (c) periodically reiterating steps (a)-(b) until the defect exceeds the allowable limit. In one embodiment, the system further comprising one or more permanently-installed ultrasonic sensors having a digital signal interface (DSI) communicatively linked with the sensor interface. In one embodiment, the communicative link is through the cloud. In one embodiment, the interface prompts the sensors to take a measurement. In one embodiment, the sensors periodically take measurements and transmit signals to the sensor interface. In one embodiment, the processor is in the cloud.

These and other advantages maybe realized in accordance with the specific embodiments described as well as other variations. It is to be understood that the above description is intended to be illustrative, and not restrictive. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled.

What is claimed is:

1. A method of monitoring defects in a structure to extend the useful operating life of said asset, said method comprising the steps of:
(a) determining a location of a defect in said asset; and
(b) causing at least one permanently installed ultrasonic sensor to be installed at said location to monitor said defect; and
(c) periodically determining whether said defect is within an allowable limit for safe operation.

2. The method of claim 1, wherein step (a) comprises performing testing on said asset to determine the location of said defect.

3. The method of claim 1, wherein step (a) comprises obtaining information on the location of said defect.

4. The method of claim 3, wherein said information is obtained from a third party.

5. The method of claim 1, wherein said step (a) comprises first determining that said asset has a defect and then determining said location of said defect.

6. The method of claim 5, wherein said determining comprises one of performing testing or causing others to perform said testing.

7. The method of claim 1, wherein, prior to step (b), a determination is made that said defect does not exceed said allowable limit.

8. A method of monitoring defects in a structure, said method comprising the steps of:
(a) obtaining first information of a possible defect in said structure based on a first detection method;
(b) obtaining second information on location of said defect in said structure based on second detection method;
(c) determining that said defect does not exceed an allowable limit and then causing at least one sensor to be installed at said location; and
(d) monitoring said structure using said sensor by periodically determining whether said defect is within allowable limits.

9. The method of claim 8, wherein, in step (a), obtaining comprises one of performing said first test method or causing others to perform said first test method.

10. The method of claim 8, wherein, in step (b), obtaining comprises one of performing said second test method or causing others to perform said second test method.

11. The method of claim 8, wherein, step (d), comprises repeatedly determining whether said defect exceeds said allowable limit.

12. The method of claim 8, wherein said first detection method does not reveal the location of said defect within structure.

13. The method of claim 12, wherein said first detection method comprises using radiography to detect wall thickness loss.

14. The method of claim 8, wherein said second detection method comprising using a hand-held ultrasonic device.

15. The method of claim 8, wherein said defect is a pit and said allowable limit is the remaining wall thickness at said location.

16. The method of claim 1, wherein periodically determining whether said defect is within allowable limits is repeated at least once a month.

17. A system for monitoring defects in a structure, said system comprising:
a sensor interface configured to receive signals from one or more sensors disposed on a surface of said structure at the location of a defect, said signals relating to the extent of said defect;
a user interface for communicating to a user when said defect exceeds an allowable limit for said defect;
a processor; and
memory configured with instruction for causing said processor to execute at least the followings steps:
(a) receiving said signals from said sensor interface relating to the extent of said defect;
(b) determining if said defect exceeds said allowable limit, and, if so, transmitting information via said user interface that said structure needs to be repaired; and
(c) periodically reiterating steps (a)-(b) until said defect exceeds said allowable limit.

18. The system of claim 17, wherein said periodically reiterating comprising performing at least once a month.

19. The system of claim 17, wherein said defect is a pit and said allowable limit is the remaining wall thickness at said location.

20. The system of claim 17, further comprising:
one or more permanently-installed ultrasonic sensors having a digital signal interface (DSI) communicatively linked with said sensor interface.
